(19) United States
(12) Patent Application Publication
(10) Pub. No.: US 2009/0322799 A1
(43) Pub. Date: Dec. 31, 2009

(54) Liquid crystal display

(75) Inventors: Wei Guo, Shenzhen (CN); Shun-Ming Huang, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY(SHENZHEN) CO., LTD.; INNOLUX DISPLAY CORP.

(21) Appl. No.: 12/459,249

(22) Filed: Jun. 29, 2009

(30) Foreign Application Priority Data
Jun. 27, 2008 (CN) 200810068074.3

(51) Int. Cl. G09G 3/36; G09G 5/10

(52) U.S. Cl. 345/690; 345/89

(57) ABSTRACT

A liquid crystal display (LCD) has a voltage generating circuit, a voltage regulating circuit, and a liquid crystal panel. The voltage generating circuit provides the liquid crystal panel with positive gray voltages and negative gray voltages. The voltage regulating circuit creates a compensating voltage lookup table recording compensated voltages according to the luminance, the positive gray voltage and the negative gray voltage of every gray level. The voltage regulating circuit regulates the positive gray voltage and the negative gray voltage using the compensated voltages recorded in the compensating voltage lookup table.

### BACKGROUND

1. Technical Field

The present disclosure relates to a liquid crystal display (LCD).

2. Description of Related Art

LCDs have been widely applied in mobile phone, personal data assistant (PDA), notebook computer, personal computer, television, and other applications. LCDs provide a screen display by applying an electrical field to two ends of a liquid crystal layer to realign liquid crystal molecules therein while controlling light transmittance intensity in collaboration with a polarizer. To prevent polarization by a unidirectional electrical field for a long duration, an inversion driving method regularly adopted alternatively applies a positive electrical field and a negative electrical field to the liquid crystal layer.

FIG. 4 shows a commonly used LCD 10 includes a voltage generating circuit 12, a data driving circuit 14, and an LCD panel 16. The voltage generating circuit 12 receives an analog VDD supply (AVDD) signal and converts the AVDD signal into a plurality of positive gray voltages. After the plurality of positive gray voltages is sent to an inverter (not shown), a plurality of negative gray voltages is obtained. The positive and negative gray voltages are sent to the data driving circuit 14. The data driving circuit 14 outputs a plurality of gray voltages to drive the LCD panel 16 in accordance with video signals generated by external circuits.

Referring to FIG. 5, the LCD panel 16 includes a plurality of pixel electrodes 161, a plurality of common electrodes 163, and a liquid crystal layer 162 sandwiched therebetween. The pixel electrodes 161 receive the positive gray voltage or the negative gray voltage. The common electrodes 163 receive a stable common voltage. An electrical field generated between the gray voltage and the common voltage twists liquid crystal molecules in the liquid crystal layer 162 at a certain degree. Each twist angle of the liquid crystal molecules in the liquid crystal layer 162 corresponds to a respective light transmittance intensity of the liquid crystal layer 162.

In an inversion driving operation, the data driving circuit 14 intermittently outputs a positive gray voltage or a negative gray voltage in accordance with the video signals generated by external circuits. As the negative gray voltage corresponding to an identical gray level is obtained after the positive gray voltage passes through an inverter, the absolute values of the positive gray voltage and the negative gray voltage are the same. The identical twist angles driven by the electrical fields with the same absolute values generate the same luminance from the LCD 10.

However, the liquid crystal molecules subjected to lengthy application of the electrical field are inevitably partially polarized. In the LCD 10 the absolute values of the positive and negative gray voltages in association with a same gray level are equivalent. Once the liquid crystal molecules are polarized, the twist angles with respect to the positive gray voltage and the negative gray voltage will be different, such that the LCD 10 exhibits two luminances with respect to the same gray level or experiences flicker.

Accordingly, the present disclosure provides an LCD to mitigate or obviate the limitations described.

### BRIEF DESCRIPTION OF THE DRAWINGS

FIG. 1 is a functional block diagram of a first preferred embodiment of an LCD in accordance with the present disclosure.

FIG. 2 is a schematic view illustrating a regulating method of the LCD of FIG. 1.

FIG. 3 is a functional block diagram illustrating an operating structure of the LCD in accordance with the present disclosure.

FIG. 4 is a functional block diagram of a commonly used LCD.

FIG. 5 is a partial cross-section of the LCD in FIG. 4.

### DETAILED DESCRIPTION

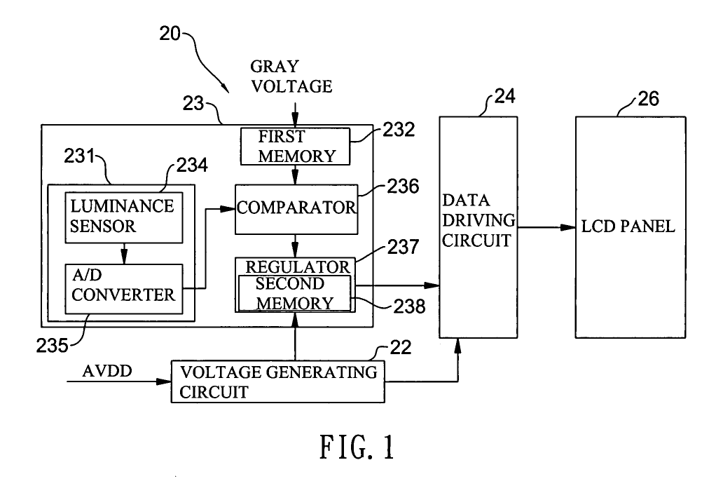

Referring to FIG. 1, an LCD 20 in accordance with the present disclosure includes a voltage generating circuit 22, a voltage regulating circuit 23, a data driving circuit 24, and a liquid crystal panel 26. The voltage generating circuit 22 receives an AVDD signal and generates a plurality of positive gray voltages. After the plurality of positive gray voltages is processed by an inverter (not shown), a plurality of negative gray voltages is obtained. The positive and negative gray voltages are transmitted to the data driving circuit 24. The voltage regulating circuit 23 is connected to the voltage generating circuit 22 to respectively output a compensated voltage with respect to the positive gray voltage and the negative gray voltage of each gray level so as to regulate the corresponding positive or negative gray voltage respectively. The data driving circuit 24 outputs a plurality of regulated positive gray voltages and negative gray voltages to drive the LCD panel 26 in accordance with video signals generated by external circuits.

The voltage generating circuit 23 includes a feedback circuit 231, a first memory 232, a comparator 236, and a regulator 237. The feedback circuit 231 includes a luminance sensor 234 and an analog to digital (A/D) converter 235. The luminance sensor 234 is mounted at a side of an output surface of the LCD panel 26, and connected to the comparator 237 via the A/D converter 235. The luminance sensor 234 detects a luminance of the LCD panel 26, and the A/D converter 235 converts analog luminance signals detected by the luminance sensor 234 into digital signals.

The first memory 232 is an erasable programmable memory and stores one or more gray level and luminance lookup tables (not shown). Each gray level and luminance lookup table records all gray levels provided by the LCD 20 and a standard luminance corresponding to each thereof. The plurality of gray level and luminance lookup tables includes various gray level and luminance relationships corresponding to different operating environments, respectively.

The comparator 236 compares a detected luminance with the standard luminance in the first memory 232. The regulator 237 outputs a compensated voltage with respect to the positive gray voltage and a compensated voltage with respect to the negative gray voltage, and regulates the compensated voltage values respectively in accordance with a comparison result from the comparator 236. The regulator 237 has a second memory 238, which is erasable and programmable and stores a gray level and compensating voltage lookup table. The gray level and compensating voltage lookup table records all the gray levels provided by the LCD 20, and the compensated voltage value of the positive gray voltage and the compensated voltage value of the negative gray voltage corresponding to each gray level.

Prior to normal operation of the LCD 20, the gray level and compensating voltage lookup table is regulated first, that is, the compensated voltage of the positive gray voltage and the compensated voltage of the negative gray voltage corresponding to each gray level are regulated.

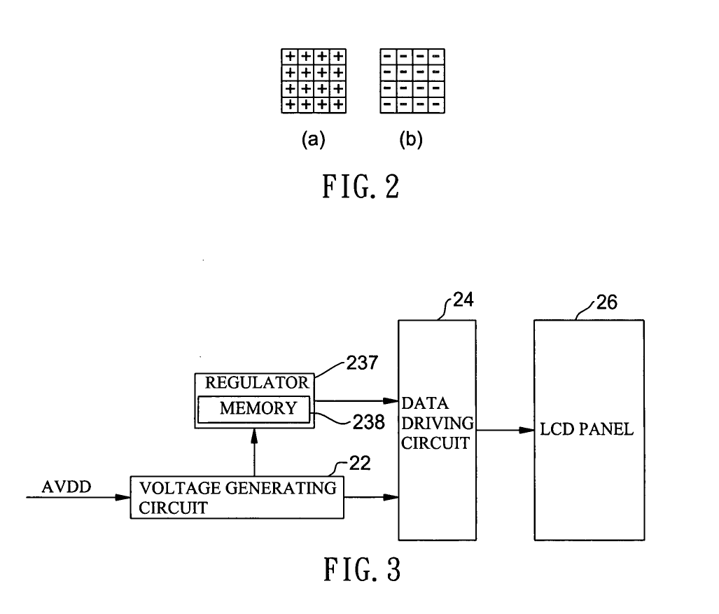

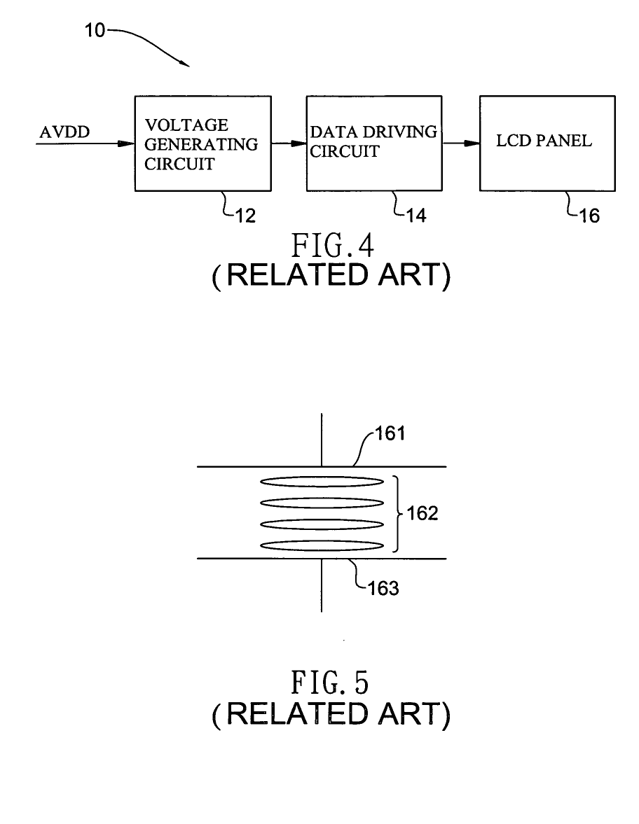

FIG. 2 is a schematic view illustrating a regulating method of the LCD 20 in accordance with the present disclosure, the regulating method as follows.

A positive gray voltage and a negative gray voltage of a gray level from the voltage generating circuit 22 are sent to the first memory 232 and the data driving circuit 24. The data driving circuit 24 sends only the positive gray voltage to all pixels of the LCD panel 26 as shown in FIG. 2(a), and drives all the pixels of the LCD panel 26 with the positive gray voltage to emit light. The luminance sensor 234 senses a luminance of the LCD panel 26 and outputs a detected luminance as an analog signal. The A/D converter 235 converts the analog signal to a detected luminance as a digital signal and transmits the signal to the comparator 236. The first memory 232 determines a gray level of the positive and negative gray voltages and identifies a standard luminance corresponding to the gray level in the gray level and luminance lookup table and outputs the standard luminance to the comparator 236.

The comparator 236 compares the standard luminance with the converted detected luminance and transmits a comparison result to the regulator 237. The regulator 237 outputs a compensated voltage to the data driving circuit 24 in accordance with the comparison result, where the positive gray voltage is regulated with the compensated voltage to vary the luminance of the LCD panel 26. The regulator 237 continuously alters the compensated voltage value in accordance with the comparison result of the comparator 236 until the converted detected luminance and the standard luminance of a same gray level in the comparator 236 are substantially identical. The corresponding compensated voltage is then stored in the second memory 238.

Likewise, when the data driving circuit 24 outputs a negative gray voltage to all the pixels of the LCD panel 26 as shown in FIG. 2(b), a compensated voltage value corresponding to the negative gray voltage is obtained by the regulator 237 and recorded in the second memory 238.

The positive gray voltage and the negative gray voltage corresponding to each gray level are output to the LCD panel 26, and the steps described are repeated until the compensated voltage values of the positive gray voltages and the compensated voltage values of the negative gray voltages corresponding to all gray levels are obtained. All compensated voltage values are stored in the second memory 238. Thus, each gray level corresponds to two compensated voltage values, that is the compensated voltage value of the positive gray voltage and the compensated voltage value of the negative gray voltage. After regulation, the gray level and compensating voltage lookup table is completed.

When the LCD 20 is regulating, the standard luminance in the gray level and luminance lookup table can be obtained based on a specific gray level and luminance curve or a luminance value fed back from the feedback circuit 231. When the standard luminance is the luminance value fed back from the feedback circuit 231, if the luminance driving the LCD panel 26 with the positive gray voltage is taken as a standard value, a luminance driving the LCD panel 26 with a negative gray voltage is fed back as the detected luminance. If a luminance driving the LCD panel 26 with a negative gray voltage is taken as a standard value, the luminance driving the LCD panel 26 with a positive gray voltage is fed back as the detected luminance.

Referring also to FIG. 3, when the LCD 20 is operating, the voltage generating circuit 22 outputs a positive (or negative) gray voltage to the second memory 238 and the data driving circuit 24. The second memory 238 identifies a compensated voltage value corresponding to the positive (or negative) gray voltage from the gray level and compensating voltage lookup table in accordance with the gray level and the polarity indicative of the positive (or negative) gray voltage and provides the compensated voltage to the regulator 237. The regulator 237 outputs a corresponding compensated voltage to the data driving circuit 24 in accordance with the compensated voltage value. The data driving circuit 24 combines the compensated voltage with the gray voltage and transmits the regulated gray voltage to the LCD panel 26 during a scanning cycle of the LCD panel 26. Additionally, the data driving circuit 24 alternately outputs the regulated positive gray voltage and negative gray voltage based on the inversion driving method.

The LCD 20 of the present disclosure utilizes the voltage regulating circuit 23. The voltage regulating circuit 23 first generates a compensated voltage value corresponding to each positive gray voltage and a compensated voltage value corresponding to each negative gray voltage in accordance with a positive gray voltage and a negative gray voltage of each gray level and a standard luminance corresponding to each gray level of the LCD panel 26. Then the regulating circuit 23 directly regulates the gray voltage with the corresponding compensated voltage value during a normal operation. The compensated voltage is regulated and obtained in accordance with the luminance of the LCD panel 26, eliminating flicker from LCD 20.

If the LCD panel 26 experiences voltage inversion, then a gray voltage is regulated according to the newly constructed gray level and compensating voltage lookup table to reduce the flicker. For example, if flicker recurs in the as a result of a change in the polarization of liquid crystal molecules in the LCD panel 26, a new gray level and compensating voltage lookup table can be reconstructed by regulating the compensated voltage value again. Accordingly, the gray voltage is regulated in accordance with the newly constructed gray level and compensating voltage lookup table to reduce the flicker. After each regulation, it is unnecessary to detect luminance of the LCD panel 26 again in operation; rather, the corresponding compensated voltage value is directly used to regulate the positive gray voltage and the negative gray voltage. As such, operation is simpler.

It is to be understood that even though numerous characteristics and advantages of the present embodiments have been set forth in the foregoing description with details of the structures and functions of the embodiments, the disclosure is illustrative only, and changes made in detail, especially in matters of shape, size, and arrangement of parts, within the principles of the embodiments, to the full extent indicated by the broad general meaning of the terms in which the appended claims are expressed.

What is claimed is:

1. A liquid crystal display (LCD) comprising:
an LCD panel;
a voltage generating circuit providing a positive gray voltage and a negative gray voltage to the LCD panel; and
a voltage regulating circuit to generate and store a data table based on a standard luminance of each gray level, and the positive gray voltage and the negative gray voltage corresponding to each gray level, and to regulate the positive gray voltage or the negative gray voltage in accordance with the data table, wherein the data table stores two compensated voltage values respectively corresponding to the positive gray voltage and the negative gray voltage of each gray level.

2. The LCD of claim 1, wherein the data table is a gray level and compensating voltage lookup table.

3. The LCD of claim 2,wherein the voltage regulating circuit comprises a regulator to regulate a corresponding gray voltage in accordance with the gray level and compensating voltage lookup table.

4. The LCD of claim 3, wherein the regulator comprises an erasable programmable memory storing the gray level and compensating voltage lookup table.

5. The LCD of claim 4, wherein the voltage regulating circuit further comprises a luminance feedback circuit to generate a detected luminance in accordance with a luminance of the LCD panel; and
a luminance memory to store the gray level and luminance lookup table, the gray level and luminance lookup table comprising a respective standard luminance to each gray level, and the regulator to vary a compensated voltage value in the gray level and compensating voltage lookup table to make a detected luminance and a standard luminance of a same gray level equivalent.

6. The LCD of claim 5, wherein a luminance of each gray level detected by the luminance feedback circuit when the LCD panel is driven by a positive gray voltage is taken as the standard luminance, and a luminance of each gray level detected by the luminance feedback circuit when the LCD panel is driven by a negative gray voltage is taken as the detected luminance.

7. The LCD of claim 5, wherein a luminance of each gray level detected by the luminance feedback circuit when the LCD panel is driven by a negative gray voltage is taken as the standard luminance, and a luminance of each gray level detected by the luminance feedback circuit when the LCD panel is driven by a positive gray voltage is taken as the detected luminance.

8. The LCD of claim 5, wherein the luminance feedback circuit comprises:
a luminance sensor to detect the luminance of the LCD panel, to generate the detected luminance and to output the detected luminance.

9. The LCD of claim 8, wherein the voltage regulating circuit further comprises a comparator to receive and to compare the detected luminance and the standard luminance and to transmit a comparison result to the regulator.

10. The LCD of claim 9, wherein the luminance feedback circuit further comprises an analog to digital converter to convert the detected luminance generated by the luminance sensor into a digital signal and to further transmit the digital signal to the comparator.

11. A liquid crystal display (LCD), comprising:
an LCD panel;
a voltage generating circuit to generate a positive gray voltage and a negative gray voltage corresponding to each gray level respectively; and
a voltage regulating circuit to generate two compensated voltage values respectively corresponding to the positive gray voltage and the negative gray voltage of each gray level, so that the positive gray voltage and the negative gray voltage of an identical gray level are combined with the corresponding compensated voltage values to drive the LCD panel to emit uniform luminance.

12. The LCD of claim 11, wherein the voltage regulating circuit comprises a regulator to output the two compensated voltage values respectively corresponding to the positive gray voltage and the negative gray voltage.

13. The LCD of claim 12, wherein the voltage regulating circuit comprises an erasable programmable memory to store the compensated voltage values respectively corresponding to the positive gray voltage and the negative gray voltage of each gray level.

14. The LCD of claim 13, wherein the voltage regulating circuit further comprises: a luminance feedback circuit to generate a detected luminance in accordance with a luminance of the LCD panel; and
a luminance memory to store the gray level and luminance lookup table, the gray level and luminance lookup table comprising a respective standard luminance corresponding to each gray level; and wherein
the positive gray voltage, the negative gray voltage and the corresponding compensated voltage drive the LCD panel to make a detected luminance and a standard luminance of an identical gray level equivalent.

15. The LCD of claim 14, wherein a luminance of each gray level detected by the luminance feedback circuit when the LCD panel is driven by a positive gray voltage is taken as the standard luminance, and a luminance of each gray level detected by the luminance feedback circuit when the LCD panel is driven by a negative gray voltage is taken as the detected luminance.

16. The LCD of claim 14, wherein a luminance of each gray level detected by the luminance feedback circuit when the LCD panel is driven by a negative gray voltage is taken as the standard luminance, and a luminance of each gray level detected by the luminance feedback circuit when the LCD panel is driven by a positive gray voltage is taken as the detected luminance.

17. The LCD of claim 14, wherein the luminance feedback circuit comprises a luminance sensor to detect a luminance of the LCD panel, to generation the detected luminance and to output the detected luminance.

18. The LCD of claim 17, wherein the voltage regulating circuit further comprises a comparator to receive and to compare the detected luminance and the standard luminance and to transmit a comparison result to the regulator.

19. The LCD of claim 18, wherein the luminance feedback circuit further comprises an analog to digital converter to convert the detected luminance generated by the luminance sensor into a digital signal and to further transmit the digital signal to the comparator.
